(19) United States
(12) Patent Application Publication
(10) Pub. No.: US 2008/0038596 A1
(43) Pub. Date: Feb. 14, 2008

(54) Method and Device for Operational Control of Fuel Cell Modules

(75) Inventor: Nathalie Cornet, Voisine Le Bretonneux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/814,085

(22) PCT Filed: Jan. 19, 2006
(86) PCT No.: PCT/FR06/50027

§ 371 Date: Jul. 17, 2007

(30) Foreign Application Priority Data
Jan. 20, 2005 (FR) 0550179

(51) Int. Cl. H01M 8/04

(52) U.S. Cl. 429/13; 429/22; 429/23

(57) ABSTRACT

A method and a device for operational control of fuel cell modules, in particular, to maintain the lifespan thereof. The electrochemical cells of the fuel cell are electrically connected to a junction box by plural modules such that control density is maintained for a given period with a weak charge and a duration of operation of a module is used such as to increase the lifespan of the fuel cell.

The present invention relates to a method and a system for managing the operation of the modules of a fuel cell unit, especially so as to maintain its lifetime.

In the prior art, constructions have been described for storing, on board a vehicle, energy in chemical form in order to recover it, on demand, in the form of electrical energy supplied to an electrical drive system for an autonomous vehicle.

Among the various electrochemical conversion devices is the fuel cell unit technique in which an assembly of electrochemical cells recovers electrical energy using at least two different electrochemical species. Electrical energy is therefore produced and consumed by at least one electric motor for driving the vehicle equipped the therewith.

The fuel cell units that can be used in particular in the automobile field are based on combining hydrogen with oxygen, the hydrogen being able to be stored on board the vehicle or produced by means of a reformer from a hydrogen-containing fuel, such as gasoline or ethanol. The oxygen to be combined with hydrogen comes from the ambient air.

An electrochemical cell for a fuel cell unit may be produced according to one of several techniques among them being the membrane-electrode assembly (MEA) technique. This technique is very sensitive to the operating conditions, particularly when these conditions modify the hydration of the membrane-electrode assembly, most particularly in the case of membranes made of a sulfonated polymer.

In particular, poor membrane-electrode assembly hydration conditions result in very rapid degradation of the cell at its membrane and are manifested by a steady drop in voltage of the order of a few microvolts per hour.

To obtain optimum operation in terms of efficiency in the fuel cell unit system, the aim is as far as possible to work with gases, especially at the cathode of the fuel cell unit, that have a low or zero moisture content.

During low-load operation, which is often the case in the complete operating cycle under actual conditions of the vehicle driven on the basis of a fuel cell unit, the cell or stack of cells is used in such a way that the delivered current density is low. Now, the lower the current density, the smaller the amount of water produced by the cell.

This situation is unfavorable in terms of water balance. As a result, the level of hydration is too great in the membrane-electrode assemblies of the electrochemical cell, thereby helping to increase the rate of degradation of the membrane-electrode assemblies.

Under steady-state operating conditions, the lifetimes of such membrane-electrode assemblies are increased tenfold when the pressure/temperature conditions and the operating ranges creating constraints on the membrane-electrode assemblies over the course of time are not modified.

In this case, the stack of electrochemical cells operates with a higher current density than in the application for electric traction in automobiles.

In the prior act, it has already been proposed to deal with the problem of membrane-electrode assembly hydration in particular by using the evaporation of the liquid parts and by discharging the liquid water onto the roadway on which the vehicle is running.

However, such solutions result in a substantial increase in the weight of the components on board the vehicle, thereby reducing the efficiency of the electric traction system.

In particular, the Applicant in its application FR-A-2 847 722, has described a reactant distribution system for fuel cell units in which the problem of water formation on a membrane-electrode assembly has been addressed.

The solution envisaged in the above patent application consists in correctly distributing the reactants, and especially in respect of the partial pressures so as to make the current density more uniform and thus distribute the thermal losses.

In this prior art, the problem stems from the fact that the membrane becomes more complicated in particular by the arrangement of additional channels.

Application US-A-2004/058206 discloses a method for improving the water balance in a stack of electrochemical cells. Each cell comprises a membrane-electrode assembly serving as anode. An anode compartment is provided for distributing the anode gas to the electrochemical cell and a porous separation plate separates a cathode gas compartment with a compartment for cooling the cell.

In this arrangement, water is exchanged between the cathode gas and the cooling unit through the porous separation plate placed between the cathode compartment and the cooling compartment using cooling of the aqueous type and the partial water vapor pressure of which is lower than that of water as a function of temperature.

Document US-A-2003/215693 discloses a fuel cell unit for reducing the voltage drop resulting from progressive contamination of the membrane-electrode assembly by using the particular construction of a separation layer.

Document De-A-101 45 875 describes a semi-wet fuel cell unit based on membrane-electrode assemblies, the electrodes of which use a layer serving as catalyst, which is applied on one side of the membrane. Through its construction and its morphology, this fuel cell unit favours back-diffusion of the reaction water through the electrolyte, thereby guaranteeing sufficient humidification of the electrolyte, while protecting the membrane-electrode assembly.

European patent application EP-A-1 220 345 discloses a cell for a fuel cell unit with a membrane-electrode assembly placed between two separators. In this prior art, the membrane-electrode assembly itself includes an electrolytic polymeric membrane and two electrode layers. Each electrode layer comprises a catalyst layer and a spacing sheet.

In these various documents of the prior art, it should be pointed out that the question of water production is dealt with using a special structure of the membrane-electrode assembly, thereby making the construction more complicated.

The present invention aims to remedy these drawbacks of the prior art.

The invention relates to a method of managing the operation of a fuel cell unit. The type of fuel cell unit in question is intended for equipping an automobile, the propulsion unit of which at least partly derives its energy from a fuel cell unit consisting of a stack of cells.

The fuel cell unit therefore comprises at least one electrochemical cell provided with a membrane-electrode assembly which is affected by specific hydration conditions. The electrochemical cell based on a membrane-electrode assembly is electrically connected via a controllable electrical junction box to other electrochemical cells.

According to the invention, the method includes a step for constituting several groups of the electrochemical cells by connecting or disconnecting in series their membrane-electrode assemblies so that the current density of the current passing through at least said electrochemical membrane-electrode assembly cell lies within a predetermined interval provided so as to maintain, whatever the electrical regime of the fuel cell unit, optimum membrane-electrode assembly hydration conditions.

The invention also relates to a system for managing the operation of a fuel cell unit for equipping an automobile, the propulsion unit of which derives at least some of its energy from a fuel cell unit consisting of a stack of cells, which essentially includes a controllable electrical junction box and a means for meat ring the relative humidity of the membrane-electrode assembly of at least one electrochemical cell and a means for controlling the electrical junction box so as to determine the series connection or the disconnection of at least one group of electrochemical membrane-electrode assembly cells so as to maintain the current density of the current passing through least said electrochemical membrane-electrode assembly cell within a predetermined range so as to maintain the durability of the fuel cell unit.

Other features and advantages of the present invention will become more clearly apparent with the aid of the following detailed description and the appended drawings in which:

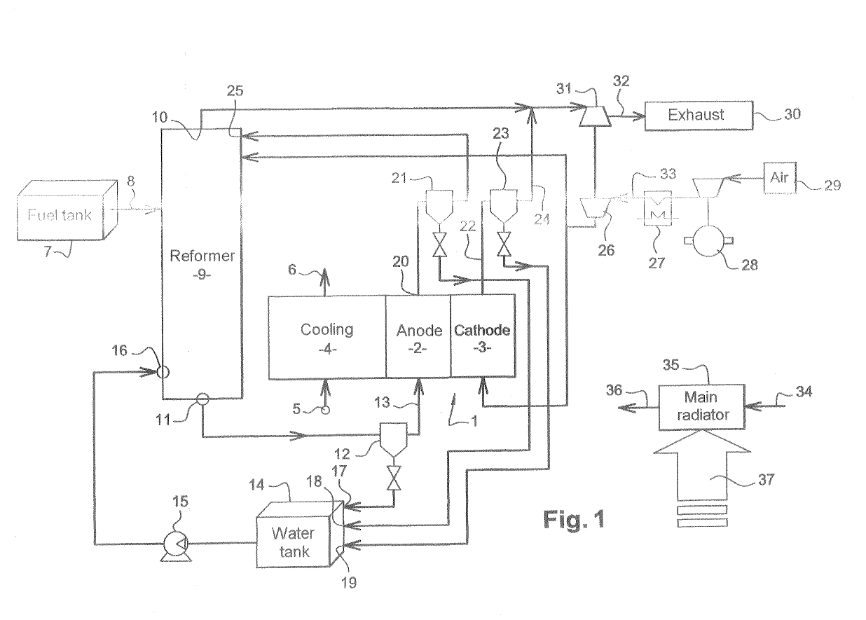

FIG. 1 is a block diagram showing the main elements of the fuel cell unit system;

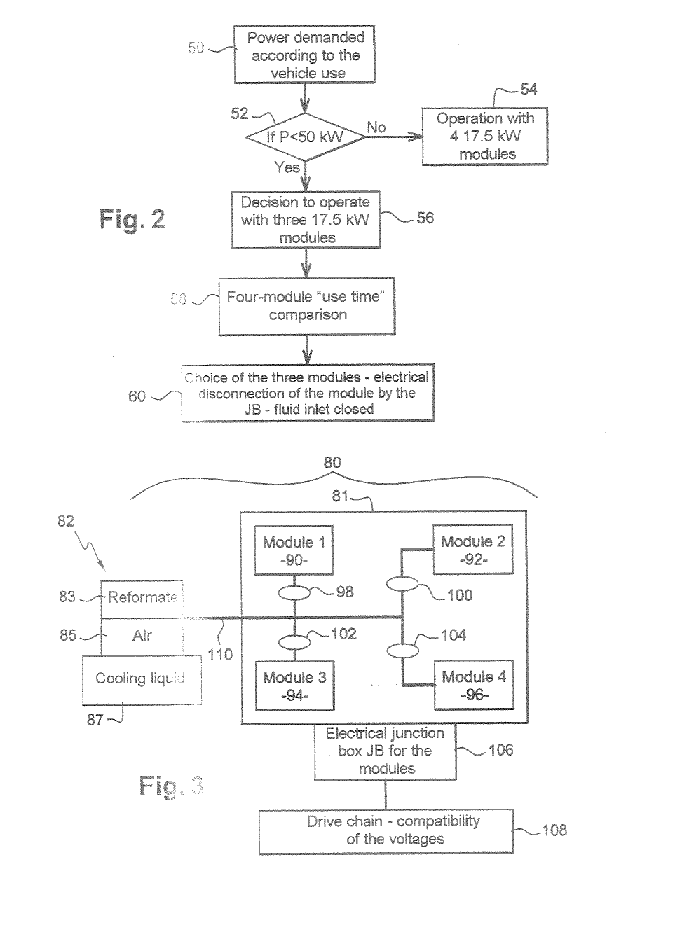

FIG. 2 shows a flow chart of the method of the invention; and

FIG. 3 shows a block diagram of a management system according to the invention.

The method of invention determines a strategy for operating a stack of electrochemical cells constituting a fuel cell unit within the context of an application in a vehicle, in which application the electrical load is not constant during the lifetime of the fuel cell unit.

Membrane-electrode assemblies (or MEAs) which are the elements forming the basis of the electrochemical reactions, located within the fuel cell unit, are very sensitive to variations in operating conditions, such as the temperature, pressure and moisture content of the gases.

For MEAs of the fluorinated or sulfonated type, the duration of problem-free operation of these assemblies may be several thousand hours, or even around ten thousand hours for a steady-state application under suitable conditions for using the MEA, in particular in which the electrical load applied to the fuel cell unit is approximately constant.

However, within the context of an automobile application, the evaluated operating conditions depend on the power demand following the conditions of use of the vehicle.

Certain operating conditions, such as a high temperature and/or a low humidity, or even operation at a relatively high voltage and/or at low humidity or even operation at a relatively high voltage (low current density), have a major impact on MEA degradation phenomena.

The negative behavior of the MEA over the course of time is manifested by a drop in potential (of the order of μV/h).

The potential drop slope, revealing the onset of degradation of the MEA, may be exacerbated to a greater or lesser extend depending on the use conditions.

The method of the invention relates to a mode of using the stack of electrochemical cells which prevents said stack of electrochemical cells from being exposed to conditions that risk accelerating the degradation of the core of the fuel cell unit, namely the MEA, and thus reducing the lifetime of the entire stack of electrochemical cells.

By carrying our trials for implementing the invention, it turns out that it is possible to achieve a lifetime of the stack of electrochemical cells of 5000 hours in continuous use.

The operation conditions causing an appreciable effect on the rate of degradation of the MEA will be described below.

The method of the invention allows the stack of electrochemical cells to be operated with the lowest possible gas moisture content, at least for the gas (air) sent to the cathode.

In the best way of implementing the invention, one step in most of the methods of managing the operation of the fuel cell units of the prior art is thus avoided, which step is that of humidifying the cathode gas. The elimination of this step of humidifying the cathode gas thus makes it possible to produce a fuel cell unit management device through which the following are achieved:
a reduction in volume of the fuel cell unit;
a cost saving with regard to the cathode humidifier, since management of the water at the cathode is facilitated; and
an energy saving, since the fuel cell unit exhibits fewer thermal losses.

Such a dry cathode mode of operation solves a problem of current fuel cell units for which the rate of degradation of most current MEAs, based on a fluorinated membrane, is much too high under these conditions.

A low gas moisture content is more problematic when the module operates at a low current density.

This is because the amount of water produced by the electrochemical reaction at the cathode is greater the higher the current density. The water produced contributes to maintaining the water balance necessary for correct operation and for the main role of the membrane.

This element conducts protons and its capability of transporting them is directly dependent on its state of swelling with water, that is to say on the number of water molecules per sulfonic site, the sulfonic sites being the proton “vehicular” sites. In one particular embodiment, the control device includes a means of measuring the relative humidity of the membrane-electrode assembly of at least one electrochemical cell so that the desired electrical connection is made by the junction box (JB or 106 in FIG. 3).

In use under vehicle conditions, the power demand may vary between about 10% of the full load and the full load, typically 70 kW.

Depending on these power demand conditions, in the current configuration of the fuel cell unit, called power module (PM) (FIG. 1) and the size of the stack of electrochemical cells in question (number of cells N, active area S, voltage V and corresponding current density J, pressure P and temperature T), the current I delivered by the stack of electrochemical cells lies in a range from about 25 A to 250 A.

For a fuel cell unit comprising N=400 cells, having an active area S=312 cm², this current range corresponds to current densities from 0.1 to 0.8 A/cm².

The method of the invention includes a step for constraining the fuel cell unit, or stack of electrochemical cells, to operate within a certain current density range. Typically, in a preferred mode of implementation, the management method of the invention makes it possible to remain within a current density range from 0.4 to 0.8 A/cm².

This mode of operation is, according to the invention, applied to a stack of electrochemical cells consisting of several modules of electrochemical cells, each of the modules being electrically connected in series. An electrochemical cell then contributes at full charge a voltage of about 0.7 V. If it is desired to limit the current to a certain value in order to reduce the ohmic losses in particular, and since the power needed to drive a vehicle is of several kW, a fuel cell unit requires several hundred electrochemical cells in series.

However, in the present state and mainly for stacking and correct-operation (homogeneity) reasons, a module is generally limited to a stack of around 100 cells at most.

In one exemplary embodiment, for a cell power of 70 kW, four 17.5 kW modules are connected in series. Each module of electrochemical cells is formed from 100 individual cells.

FIG. 1 shows a fuel cell unit with reforming, which makes it possible to generate electric power for supplying an electric motor, for example for driving a vehicle.

The system comprises a reformer 9, for generating hydrogen from a fuel, such as gasoline or methanol stored at 7, 8 on board the vehicle, a fuel cell unit 1 for generating the electric power from the hydrogen supplied by the reformer 9 and oxygen from the air 29, and auxiliary equipment. especially an air compressor 28 and a cooling circuit 34-36 and 4-6.

The fuel cell unit may consist of a plurality of cells connected in series in order to achieve the operating voltage of the vehicle drive chain. The cells are dimensioned according to the nominal power of the drive chain that has to be achieved.

A cell of a fuel cell unit comprises a bipolar plate and a membrane-electrode assembly. The cell consumes hydrogen output from the reformer 9, so as to form protons and electrons at the anode 2. The protons are transferred through the membrane and the electrons are transferred by the bipolar plates to the electrical circuit (not shown in FIG. 1) at the output of the fuel cell unit. At the cathode 3, the oxygen from the air taken from he outside 29 by means of a first compressor 28 and of an exchanger 27 which is connected via a second compressor 26, 32 one side to the cathode 3 and on the other side to a suitable inlet 25 of the reformer 9. The oxygen combines with the protons and the electrons to form water, which is collected in a water tank 19 via access points 20 on the anode 2 and is drawn by arrangements known from the prior art 21-24 for inlets 18 and 19. A water pump sends the water to the reformer 9 via an inlet 16, whereas the excess water is recycled via an outlet 11 of the reformer 9 by means of a recycling circuit comprising a pump 12 that delivers to anode, in order to control the hydration of the anode 2, and to an inlet 17, directly or via a valve, the tank 14.

The electrochemical cell modules which together form a stack of electrochemical cells are not electrically connected directly together, but their electrical connection is made by a junction box (JB) connected by means for electrically connecting electrochemical cells and modules of electrochemical cells to the power electronics and via means for controlling to the control unit, the power electronics and the control unit being internal to the vehicle in which the fuel cell unit is placed.

In one particular embodiment, the junction box includes a means for electrically isolating one or more modules of electrochemical cells.

In one particular embodiment, the means for electrically isolating one or more modules cooperates with a means for detecting a module that has become defective. When the means for detecting that a module has become detective detects the address of a module that has become defective, it transmits the address of the defective module to the means for electrically isolating one or more modules, which then electrically isolates of the defective module by acting on its electrical condition so as to isolate the defective module from the series connection in the module of cells to which it belongs.

In one particular embodiment, the means for detecting that a module that has become defective also includes a means for indicating the existence of a defective module. Such an indication may be displayed using a failure-indicating means such as a warning lamp on the instrument panel of the vehicle.

In one particular embodiment, the means for indicating the existence of a defective module also includes a means for controlling the power electronics and the control unit that are internal to the vehicle in which the fuel cell unit is placed, in order to allow the power delivered by the remaining modules to be used so as to go to a fuel cell maintenance point.

In one particular embodiment, the control means for using the power delivered by the remaining modules cooperates with a means for indicating the geographical position of the maintenance point of the fuel cell unit.

Thanks to the electrical configuration of the modules of electrochemical cells applied by the junction box JB for electrically isolating one or more modules, the method of the invention includes a step for actuating a mode of operation of the stack of electrochemical cells that determines the range or interval of the current density values within which the stack of electrochemical cells will operate.

In one particular embodiment of the invention, the device for managing the fuel cell unit also includes a means for opening and/or closing fluid isolation valves for interrupting the anode gas flows and/or cathode gas flows leading to a cell and/or to a module of electrochemical cells that has been disconnected from the fuel cell unit via the junction box JB.

In one particular mode of implementing the invention, the step for disconnecting an electrochemical cell and/or a module of electrochemical cells is supplemented with a step of interrupting the anode gas flow and cathode gas flow for the module to be temporarily disconnected.

In a preferred mode of implementation, to achieve the target current density range, the method consists in operating the fuel cell unit with one, two, three of four modules in four.

In one mode of implementation, the method of the invention includes a step for determining at least one module to be temporarily disconnected, which will ensure that the fuel cell unit s electrically operated within a predetermined current density range that ensures durability of the fuel cell unit.

In one particular mode of implementation, the method of the invention includes a prior step for taking into consideration the compatibility of the mode of operating the fuel cell unit actuated by the method of the invention at the step for disconnecting at least one electrochemical cell and/or a module of electrochemical cells, with the possible operating mode of the power electronids and of the electric traction system.

Tn particular, the prior step for taking into consideration for compatibility of the operating mode of the fuel cell unit includes a test for the compatibility of the disconnection as a function of the operation of voltages of the power electronics and of the electric traction system.

In the present state, this constraint limits the possible operation to three or four modules in four.

On this basis, the benefit of three-module operation instead of four-module operation is the following.

The power range close to 10 kW corresponds to a pressure of about 1.5 bar for operating the fuel cell unit, which has an impact on its response via the polarization curve.

The cell is designed, at start-up, for full load and a pressure of 3.4 bar.

Under these conditions, referring to the voltage U/current density J characteristic of the fuel cell unit at an operating pressure of 1.5 bar, the following exemplary configurations were obtained:
configuration A: four modules combining 400 cells with J=0.1 A/cm² U=0.82 V, Uₘᵢₙ=328 V−400 V and P=10 kW; and
configuration B: three modules in groups of 300 cells, J=0.15 A/cm², U=0.8 V, Uₘᵢₙ=240 V−300 V and P=11 kW.

In the exemplary embodiments of configurations A, B and C (see later), denotes the current density per cell, U denotes the service voltage of each cell, Uₘᵢₙ denotes the minimum operating voltage of the fuel cell unit and P denotes its service electric power.

The mode of operation in configuration B is extremely favorable, even if the preferred current density range cannot be achieved. It ought to be able to go down to a single module, something which is not possible in relation to the operating compatibility with the rest of the system. The mode of operation in configuration B makes it possible to “depart” from the unstable region of the response of the fuel cell unit corresponding to the activation zone; in addition, operation at 0.8 V appears to be a maximum, as above this voltage the active layer, and in particular the catalysts developed for operation with a reformer, are much more unstable have a shorter lifetime.

The same applied to the membrane: flow at 0.15 A/cm² is better for the membrane and dry cathode operation than flow at 0.1 A/cm².

The rather low power demand represents the situation over most of the operating time under actual conditions of the system.

This also means that, by operating in this way with three modules under low power demand conditions, by not using one module for a very long time it is possible to increase the lifetime of the overall fuel cell unit.

In one particular mode of implementing the method of the invention, the step of disconnecting an electrochemical cell and/or at least one module of electrochemical cells includes the step for selecting, according to a disconnection time distribution law for each disconnectable electrochemical cell and/or each module, at least one said electrochemical cell and/or at least one said module of electrochemical cells so as to equitably distribute, over all the electrochemical cells, the current-density operating conditions that allow their lifetime to be extended. In practice, this step consists in rotating the use of the three modules.

In one embodiment of the system of the invention, the system for managing the fuel cell unit includes a control means for choosing the module of electrochemical cells to be disconnected, from among the connected modules, so as to extend their lifetime and capable of distributing the duration with use with this objective.

The method of managing the fuel cell unit may also be put into practice for higher power demands, for example for a power of 30 kW (with reference to the U-j response of the fuel cell unit at an operating pressure of 2.5 bar, the previous configurations were obtained:
configuration A: four modules combining 400 cells, J=0.3 A/cm², U=0.77 V, Uₘᵢₙ=310 V−400 V and P=30 kW; and
configuration B: three modules representing 300 cells, J=0.43 A/cm², U=0.74 V, Uₘᵢₙ=222 V−400 V, P=30 kW.

The threshold power for deciding to switch to three modules instead of four is approximately located at around 50 kW (FIG. 2).

For higher power levels, the voltage of the fuel cell unit for the corresponding current density allowing the demanded power to be achieved would be too low (impact on the efficiency of the system).

The advantages of managing the fuel cell unit during operation with three modules are given below, the method of the invention making it possible:
to improve the lifetime of the stack of electrochemical cells. Two aspects contribute to increasing the lifetime of the stack of electrochemical cells:
   the operation of three modules under favorable current-density and voltage conditions for the membrane-electrode-assembly (MEA) and
   the economy of operation of the equivalent of approximately one module: increase in use time of the stack of electrochemical cells;
using the management method of the invention, one management step makes it possible to achieve an objective of increasing the efficiency of the system over the complete operating cycle of the fuel cell unit installed on the vehicle, by preventing operation at very low current density, a region corresponding to the lowest efficiency of the system. To achieve this operating mode, it is necessary for the fuel cell unit to be current-controlled.

This amounts to having, on the same bases as previously for an operating pressure of 1.5 bar:
Configuration C: two modules comprising 200 cells, J=0.22 A/cm², U=0.76 V, Uₘᵢₙ=152 V−200 V, P=10 kW.

A fuel cell unit configuration such as configuration C allows the lifetime of the stack of electrochemical cells to be doubled.

FIG. 2 summarizes one particular mode of implementation of the method of the invention in the form of a flow chart of the various steps, which are, respectively:
a step 50 during which the demanded electric power according to the use of the vehicle is estimated; then
a test step 52 for determining whether the estimated power P is below a threshold value, such as 50 kW; then
if the test 52 is negative, a step 54 obliging the fuel cell unit to be operated with four modules of 100 electrochemical cells, each having at least one quarter of the maximum electric power that can be demanded;
otherwise, if test 52 is positive, a step 56 of deciding on an operation of the fuel cell unit with three modules of 100 electrochemical cells, each having at least one quarter of the maximum electric power that can be demanded, then;
a step 56 for determining the module to be disconnected as a function of the instantaneous value of the use time recorded for each module of the fuel cell unit; and then
a step 60 of choosing the three modules that will remain connected before the command by the junction box JB for disconnecting the module to be disconnected as a function of the various values taken by the variables storing the use time of each module so as to optimize the lifetime of the fuel cell unit, step 60 being, where appropriate, supplemented with a step of closing the fluid inflows on the fluid inlets of the disconnected module.

FIG. 3 shows a block diagram of a system for managing a fuel cell unit for a motor vehicle according to the invention.

The system includes the conventional fuel cell unit surfaces device 82 already described in FIG. 1, which essentially comprise the reformer 83, an air supply 85 and a source of coolant 87. The assembly is placed under the control of a control computer 80 and includes a state 81 of electrochemical cells such as the electrochemical cell 1 described in FIG. 1. The 400 electrochemical cells are grouped in four modules 90 to 96 and are supplied with fluids via a fluid distribution network 110 that distributes the proton flux, the anode flux and the cooling flux to the cells of the four modules through controlled solenoid valves 98 to 104.

The electrical terminals (not shown) of the electrochemical cells of the modules 90 to 96 are taken via suitable connectors to the junction box JB 106 for the modules that the electrical energy is transmitted to the traction chain 108 while the latter returns to the control computer 80 the information about the compatibility of the voltages of the modules with the voltage demanded by said traction chain in order to allow the control computer 80 to determine, as described above the module to be disconnected.

1-15. (canceled)

16. A method of managing operation of a fuel cell unit of a type cooperating with a reformer, in which a cell unit of at least one electrochemical cell including a membrane-electrode assembly is electrically connected via a controllable electrical junction box to other electrochemical cells, the method comprising:
constituting plural groups of the electrochemical cells by connecting or disconnecting in series their membrane-electrode assemblies so that current density of current passing through at least the electrochemical membrane-electrode assembly cell lies within a predetermined interval provided so as to maintain, whatever an electrical regime of the fuel cell unit, optimum membrane-electrode assembly hydration conditions.

17. The method as claimed in claim 16, further comprising:
controlling an operating mode of the groups of electrochemical cells that determines a range or interval of current density values within which the groups of electrochemical cells will operate.

18. The method as claimed in claim 16, wherein, to achieve a targeted current density range, the method makes the cell operate by electrically connecting or disconnecting at least one module among the modules.

19. The method as claimed in claim 18, further comprising:
disconnecting an electrochemical cell and/or a module of electrochemical cells, together with interrupting an anode gas flow and cathode gas flow for the module to be temporarily disconnected.

20. The method as claimed in claim 16, further comprising:
determining at least one module to be temporarily disconnected, which will ensure that the fuel cell unit is electrically operated within a predetermined current density range that ensures durability of the fuel cell unit.

21. The method as claimed in claim 18, further comprising:
a prior taking into consideration of compatibility of a mode of operating the fuel cell unit actuated at disconnecting at least one electrochemical cell and/or a module of electrochemical cells, with a possible operating mode of power electronics and of an electric traction system.

22. The method as claimed in claim 21, wherein the prior taking into consideration the compatibility of the operating mode of the fuel cell unit includes a test for compatibility of the disconnection as a function of operation of voltages of the power electronics and of the electric traction system.

23. A system for managing operation of a fuel cell unit of a type cooperating with a reformer for equipping an automobile, a propulsion unit of which derives at least some of its energy from a fuel cell unit of a stack of cells, the system comprising:
a controllable junction box; and
means for determining a series connection or a disconnection of at least one group of electrochemical membrane-electrode assembly cells so as to maintain a current density of current passing through at least the electrochemical membrane-electrode assembly cell within a predetermined range.

24. The system as claimed in claim 23, further comprising:
means for measuring relative humidity of the membrane-electrode assembly of at least one electrochemical cell so that the electrical connection is made by the junction box, connected by means for electrically connecting electrochemical cells and modules of electrochemical cells to an electronic power module and by control means, power electronics and the control means being internal to the vehicle in which the fuel cell unit is placed.

25. The system as claimed in claim 23, wherein the junction box includes means for electrically isolating one or more modules of electrochemical cells.

26. The system as claimed in claim 25, wherein the means for electrically isolating one or more modules cooperates with a means for detecting a module that has become defective, which transmits an address of the defective module to the means for electrically isolating one or more modules, which then electrically isolates the defective module by acting on its electrical connection so as to isolate the defective module from the series connection in the module of cells to which it belongs.

27. The system as claimed in claim 26, wherein the means for detecting a module that has become defective also includes a means for signaling existence of a defective module, a failure-indicating means, or a warning lamp on the instrument panel of the vehicle.

28. The system as claimed in claim 26, wherein the means for indicating the existence of a defective module also cooperates with a means for controlling power electronics and the control unit that are internal to the vehicle in which the fuel cell unit is placed, so as to allow power delivered by the remaining modules to be used so as to go to a maintenance point of the fuel cell unit.

29. The system as claimed in claim 28, wherein the control means for using the power delivered by the remaining modules cooperates with a means for indicating geographical position of the maintenance point of the fuel cell unit.

30. The system as claimed in claim 24, further comprising means for opening and/or closing fluid isolation valves for interrupting an anode gas flows and/or cathode gas flows leading to a cell and/or to a module of electrochemical cells that has been disconnected from the fuel cell unit via the junction box.
